(19) United States
(12) Patent Application Publication
(10) Pub. No.: US 2026/0259969 A1
(43) Pub. Date: Sep. 3, 2026

(54) SYSTEM AND METHOD FOR VERIFYING MOTOR CARRIER IDENTITY USING PUBLIC AND PRIVATE DATA

(71) Applicant: Verified Carrier, LLC, Vancouver, WA (US)

(72) Inventor: Alex Panfilov, Vancouver, WA (US)

(21) Appl. No.: 19/553,984

(22) Filed: Mar. 2, 2026

Related U.S. Application Data
(60) Provisional application No. 63/766,249, filed on Mar. 3, 2025.

(51) Int. Cl. G06F 21/32

(52) U.S. Cl. CPC G06F 21/32

(57) ABSTRACT

A method for carrier verification, comprising receiving carrier identification data, biometric submissions comprising biometric data, and fleet data comprising location-specific data; transforming location-specific data into regional data; validating the carrier identification data against a plurality of third-party databases; processing an identity verification based on the biometric data; analyzing temporal patterns of the biometric submissions; cross-referencing carrier data between public and private sources; determining a verification status based on the carrier identification data, regional data, identity verification, and temporal patterns; and continuously monitoring verification status through automated data source surveillance. The method can include transforming regulatory data into historical datasets for pattern analysis and detection of affiliated entities. The method can establish legal ownership through triangulation of banking information, government records, and biometric data validation, while preventing duplicate ownership claims through temporal analysis of biometric submissions.

### CROSS-SECTION TO RELATED APPLICATION(S)

The present application claims priority to U.S. Provisional Patent No. 63/766,249, titled “SYSTEM AND METHOD FOR VERIFYING MOTOR CARRIER IDENTITY USING PUBLIC AND PRIVATE DATA,” and filed Mar. 3, 2025, the entirety of which is incorporated by reference herein.

### TECHNICAL FIELD

The present disclosure relates to identity verification systems.

### BACKGROUND

The transportation and logistics industry relies on accurate verification of motor carriers to prevent fraud, enhance safety, and ensure compliance with regulatory requirements. Existing identity verification systems primarily depend on public databases, which may contain outdated or unconfirmed, self-declared or incomplete information. Fraudsters can exploit these gaps by misrepresenting their identity or credentials, leading to financial losses and security risks for shippers, brokers, and other stakeholders.

While some verification solutions allow user-provided data input, they often lack robust mechanisms to cross-check this information against multiple sources to detect inconsistencies or fraudulent activity. Additionally, current verification methods may be time-consuming, requiring manual reviews or extensive documentation submissions. Solutions that rely on algorithms applied to public records can be erroneous due to the unreliable nature of public data, leading to incorrect verification outcomes. Furthermore, there is no existing solution that allows for continuous monitoring of changes to carrier data, making it difficult to track updates or detect emerging risks over time. There is a need for a more efficient, automated, and accurate approach to motor carrier identity verification that leverages both public and private data sources while providing ongoing monitoring capabilities.

### SUMMARY

In some embodiments, a computer-implemented method for motor carrier verification includes receiving, by a processor, carrier identification data, biometric submissions including biometric data, and fleet data comprising location-specific data; transforming, by the processor, location-specific data into regional data; validating, by the processor via a network interface, the carrier identification data against a plurality of third-party databases; processing, by the processor, an identity verification based on the biometric data; analyzing, by the processor, temporal patterns of the biometric submissions; cross-referencing, by the processor, carrier data between public and private sources; determining, by the processor, a verification status based on the carrier identification data, regional data, identity verification, and temporal patterns; and continuously monitoring, by the processor, verification status through automated data source surveillance.

In some embodiments, analyzing temporal patterns includes storing, by the processor, timestamps of biometric submissions; detecting, by the processor, sequential submission patterns; identifying, by the processor, multiple submissions across different carrier accounts; and automatically disqualifying, by the processor, subsequent submissions from previously verified individuals.

In some embodiments, cross-referencing carrier data includes extracting, by the processor, data through optical character recognition from documentation, wherein the carrier identification data comprises the documentation; validating, by the processor, portions of the extracted data against government records; verifying, by the processor, banking relationships in the extracted data against banking records; confirming, by the processor, insurance coverage in the extracted data through automated provider communication; and detecting, by the processor, affiliated entities through pattern matching of the extracted data.

In some embodiments, continuously monitoring verification status further includes collecting, by the processor, carrier operational data including contact information and vehicle identification numbers; analyzing, by the processor, patterns in the contact information; comparing, by the processor, vehicle identification numbers across carriers; detecting, by the processor, representative overlap between carriers; and generating, by the processor, relationship maps based on the representative overlap.

In some embodiments, the method further includes receiving, by the processor, real-time carrier data from FMCSA databases; storing, by the processor, snapshots of the real-time carrier data at predetermined intervals; creating, by the processor, temporal relationships between the snapshots; generating, by the processor, historical patterns from temporal relationships; detecting, by the processor, changes in carrier status over time based on the historical patterns; and establishing, by the processor, baseline operational patterns for continuous monitoring based on the changes in carrier status.

In some embodiments, generating historical patterns includes aggregating, by the processor, sequential snapshots; identifying, by the processor, temporal relationships between changes in carrier status; creating, by the processor, carrier activity timelines based on the temporal relationships and aggregated snapshots; detecting, by the processor, patterns in operational changes based on the carrier activity timelines; and establishing, by the processor, normal versus abnormal behavior patterns based on the patterns in operational changes.

In some embodiments, the method includes correlating, by the processor, the historical patterns with the real-time carrier data; identifying, by the processor, deviations from the historical patterns; generating, by the processor, risk assessments based on deviations; predicting potential compliance issues based on the risk assessments; and automatically adjusting continuous monitoring frequency based on the potential compliance issues.

In some embodiments, the method further includes receiving, by the processor, banking credentials from a purported owner; obtaining, by the processor, business registration data from Secretary of State records; retrieving, by the processor, carrier authorization data from FMCSA databases; collecting, by the processor, vehicle registration documentation; triangulating, by the processor, ownership information across the banking credentials, the Secretary of State records, the carrier authorization data, the vehicle registration documentation, and the biometric data; generating, by the processor, an ownership confidence score based on the triangulation; and establishing, by the processor, legal ownership identity based on the ownership confidence score.

In some embodiments, triangulating ownership information includes matching, by the processor, business names and business addresses from the banking credentials, the business registration data, the carrier authorization data, and the vehicle registration documentation; comparing, by the processor, ownership names across the banking credentials, the business registration data, the carrier authorization data, and the vehicle registration documentation; validating, by the processor, consistency of the business addresses; verifying, by the processor, consistency of the ownership names; cross-referencing, by the processor, the biometric data against the ownership names; and identifying, by the processor, temporal patterns in the ownership names through biometric submissions.

In some embodiments, the method further includes establishing, by the processor, temporal sequence of the ownership information; detecting, by the processor, ownership changes from at least one of the banking credentials, the business registration data, the carrier authorization data, and the vehicle registration documentation; identifying, by the processor, attempts to claim multiple ownerships based on the biometric submissions; automatically flagging, by the processor, ownership discrepancies based on the attempts to claim multiple ownerships and the ownership changes; in response to flagging: requesting, by the processor, additional verification and preventing, by the processor, sequential ownership claims based on the biometric submissions; and maintaining, by the processor, continuous ownership validation through the continuous monitoring.

In some embodiments, a system for motor carrier verification includes a processor and a non-transitory, processor-readable storage medium, wherein the non-transitory, processor-readable storage medium comprises one or more programming instructions. The one or more programming instructions when executed, may cause the processor to receive carrier identification data, biometric submissions comprising biometric data, and fleet data comprising location-specific data; transform location-specific data into regional data; validate, via a network interface, the carrier identification data against a plurality of third-party databases; process an identity verification based on the biometric data; analyze temporal patterns of the biometric submissions; cross-reference carrier data between public and private sources; determine a verification status based on the carrier identification data, regional data, identity verification, and temporal patterns; and continuously monitor verification status through automated data source surveillance.

In some embodiments, the one or more programming instructions that cause the processor to analyze temporal patterns further cause the processor to store timestamps of biometric submissions; detect sequential submission patterns; identify multiple submissions across different carrier accounts; and automatically disqualify subsequent submissions from previously verified individuals.

In some embodiment, the one or more programming instructions that cause the processor to cross-reference carrier data further cause the processor to extract data through optical character recognition from documentation, wherein the carrier identification data comprises the documentation; validate portions of the extracted data against government records; verify banking relationships in the extracted data against banking records; confirm insurance coverage in the extracted data through automated provider communication; and detect affiliated entities through pattern matching of the extracted data.

In some embodiments, the one or more programming instructions that cause the processor to continuously monitor verification status further cause the processor to collect carrier operational data comprising contact information and vehicle identification numbers; analyze patterns in the contact information; compare vehicle identification numbers across carriers; detect representative overlap between carriers; and generate relationship maps based on the representative overlap.

In some embodiments, the one or more programming instructions further cause the processor to receive real-time carrier data from FMCSA databases; store snapshots of the real-time carrier data at predetermined intervals; create temporal relationships between the snapshots; generate historical patterns from temporal relationships; detect changes in carrier status over time based on the historical patterns; and establish baseline operational patterns for continuous monitoring based on the changes in carrier status.

In some embodiments, the one or more programming instructions that cause the processor to generate historical patterns further cause the processor to aggregate sequential snapshots; identify temporal relationships between changes in carrier status; create carrier activity timelines based on the temporal relationships and aggregated snapshots; detect patterns in operational changes based on the carrier activity timelines; and establish normal versus abnormal behavior patterns based on the patterns in operational changes.

In some embodiments, the one or more programming instructions further cause the processor to correlate the historical patterns with the real-time carrier data; identify deviations from the historical patterns; generate risk assessments based on deviations; predict potential compliance issues based on the risk assessments; and automatically adjust continuous monitoring frequency based on the potential compliance issues.

In some embodiments, the one or more programming instructions further cause the processor to receive banking credentials from a purported owner; obtain business registration data from Secretary of State records; retrieve carrier authorization data from FMCSA databases; collect vehicle registration documentation; triangulate ownership information across the banking credentials, the Secretary of State records, the carrier authorization data, the vehicle registration documentation, and the biometric data; generate an ownership confidence score based on the triangulation; and establish legal ownership identity based on the ownership confidence score.

In some embodiments, the one or more programming instructions that cause the processor to triangulate ownership information further cause the processor to match business names and business addresses from the banking credentials, the business registration data, the carrier authorization data, and the vehicle registration documentation; compare ownership names across the banking credentials, the business registration data, the carrier authorization data, and the vehicle registration documentation; validate consistency of the business addresses; verify consistency of the ownership names; cross-reference the biometric data against the ownership names; and identify temporal patterns in the ownership names through biometric submissions.

In some embodiments, the one or more programming instructions further cause the processor to establish temporal sequence of the ownership information; detect ownership changes from at least one of the banking credentials, the business registration data, the carrier authorization data, and the vehicle registration documentation; identify attempts to claim multiple ownerships based on the biometric submissions; automatically flag ownership discrepancies based on the attempts to claim multiple ownerships and the ownership changes; in response to flag request additional verification and prevent sequential ownership claims based on the biometric submissions; and maintain continuous ownership validation through the continuous monitoring.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIGS. 1A-1I illustrate views of an example sequence diagram for a carrier verification process, detailing the interactions between system components and the sequential flow of verification steps in accordance with an embodiment.

FIG. 2 provides a detailed illustration of system components and their relationships in accordance with an embodiment.

FIG. 3 illustrates a carrier identification process in accordance with an embodiment.

FIG. 4 depicts an initial verification phase in accordance with an embodiment.

FIG. 5 illustrates a company information collection phase in accordance with an embodiment.

FIG. 6 illustrates a user identity verification process in accordance with an embodiment.

FIG. 7 illustrates a legal owner identity verification process in accordance with an embodiment.

FIG. 8 illustrates a carrier verification process in accordance with an embodiment.

FIG. 9 demonstrates a status assignment and monitoring system in accordance with an embodiment.

FIG. 10 illustrates an example networked computing arrangement in accordance with some embodiments.

FIG. 11 shows an example computing device which may be used in the systems and methods described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the disclosures to these particular embodiments.

The present invention provides a system and method for verifying the identity of a motor carrier by integrating and analyzing both public data sources and private, user-provided information. The system may automate the verification process by retrieving data from government and industry databases, cross-referencing it with details submitted by the carrier, and/or applying machine learning algorithms or rule-based logic to detect inconsistencies or fraudulent behavior. These algorithms may be based or trained on historical behavior information and applied to real-time data.

A method can include collecting public data from sources such as the Federal Motor Carrier Safety Administration (FMCSA), Department of Transportation (DOT), and other regulatory agencies (Secretary of State, Department of Motor Vehicles); receiving, from users (e.g., motor carriers, brokers), private identity-related data, including business details, ownership information, and operational history; cross-verifying the submitted data against the retrieved public records to identify discrepancies, inconsistencies, or indicators of fraudulent activity; generating a verification score or status that reflects the trustworthiness and legitimacy of the motor carrier; and/or providing stakeholders with a report detailing the verification results and any identified risks. In some aspects, users permit access to 3rd party services as additional independent sources of truth.

By combining public and private data, the system may enhance the accuracy, reliability, and efficiency of motor carrier identity verification, reducing fraud risks and improving trust within the transportation industry.

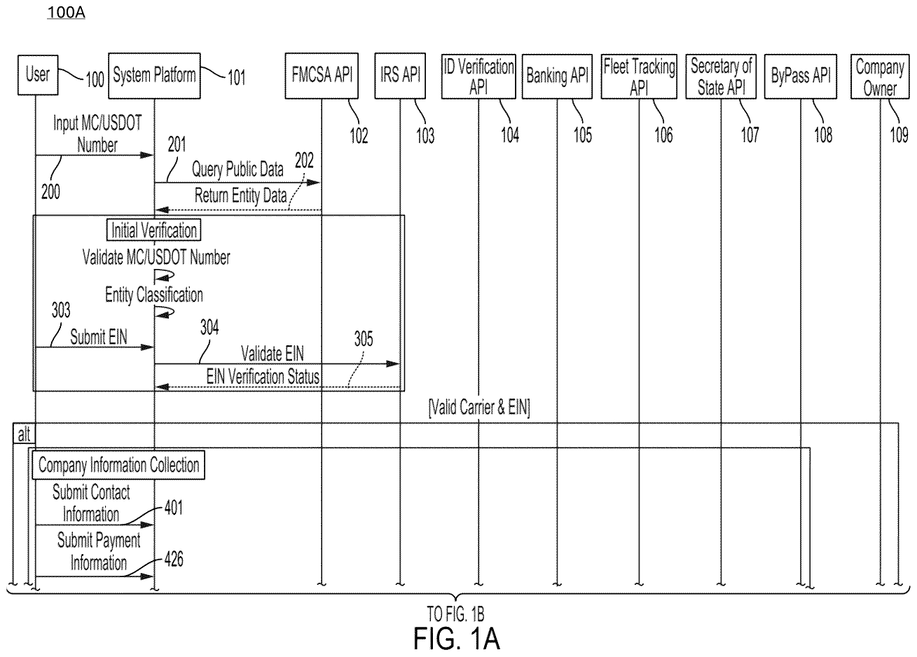

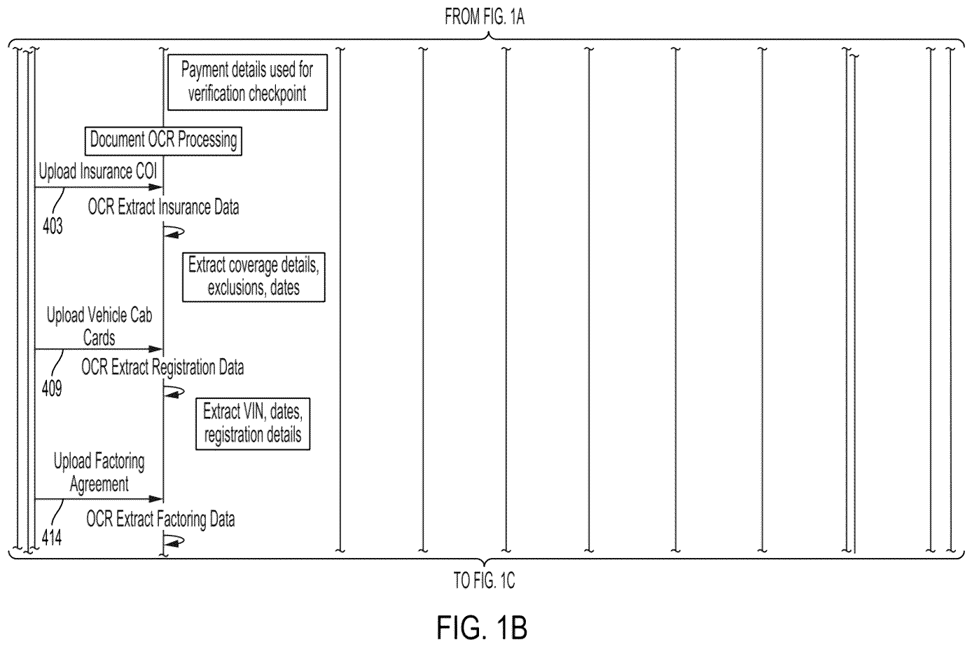

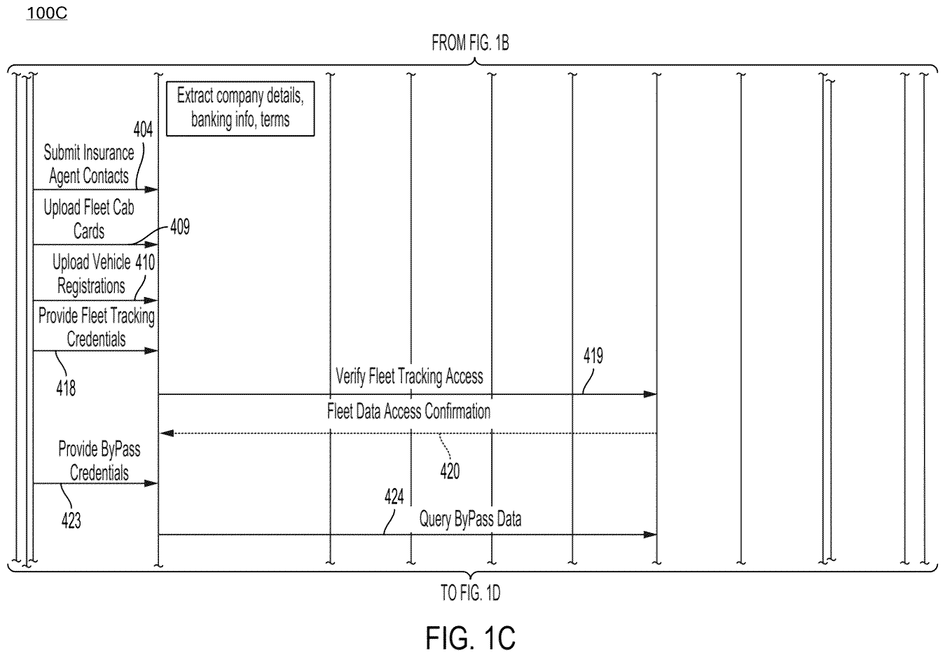

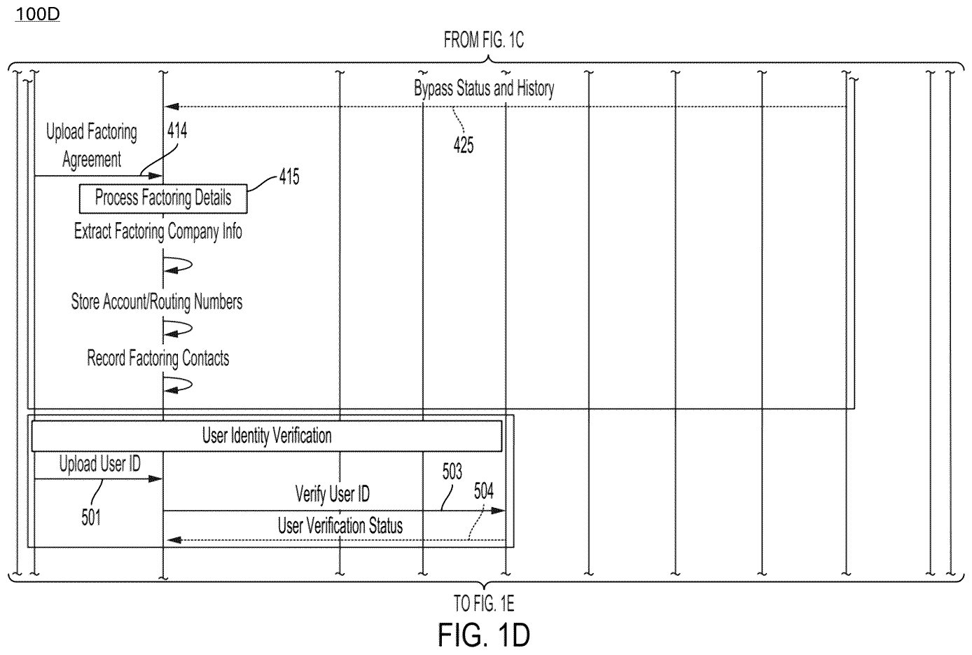

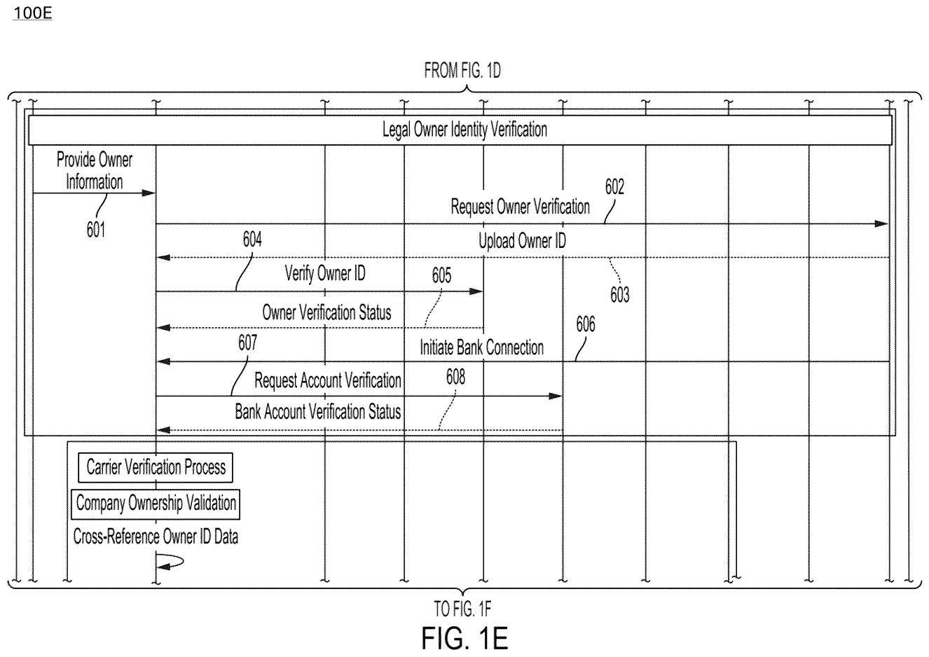

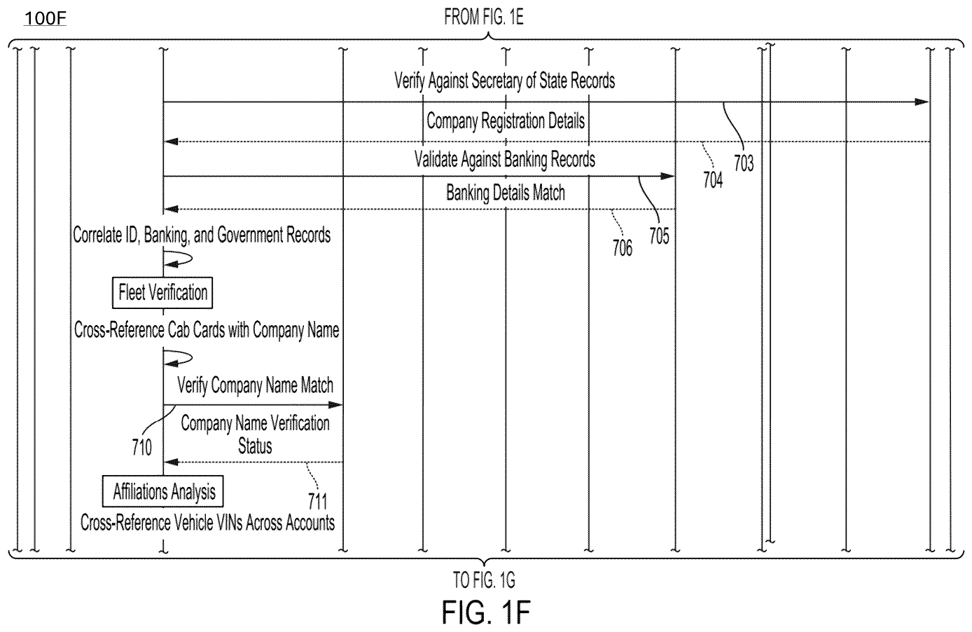

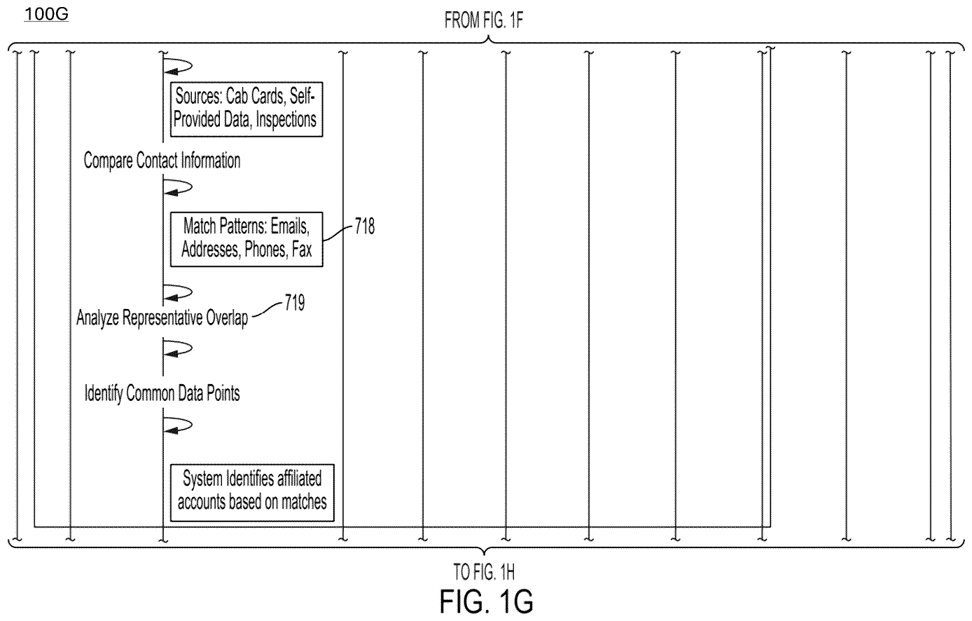

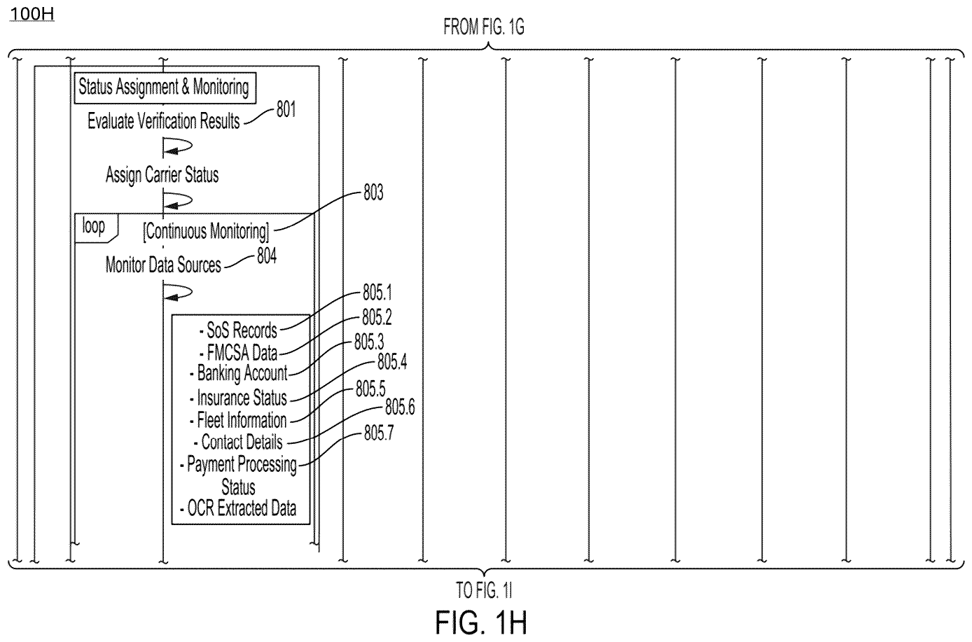

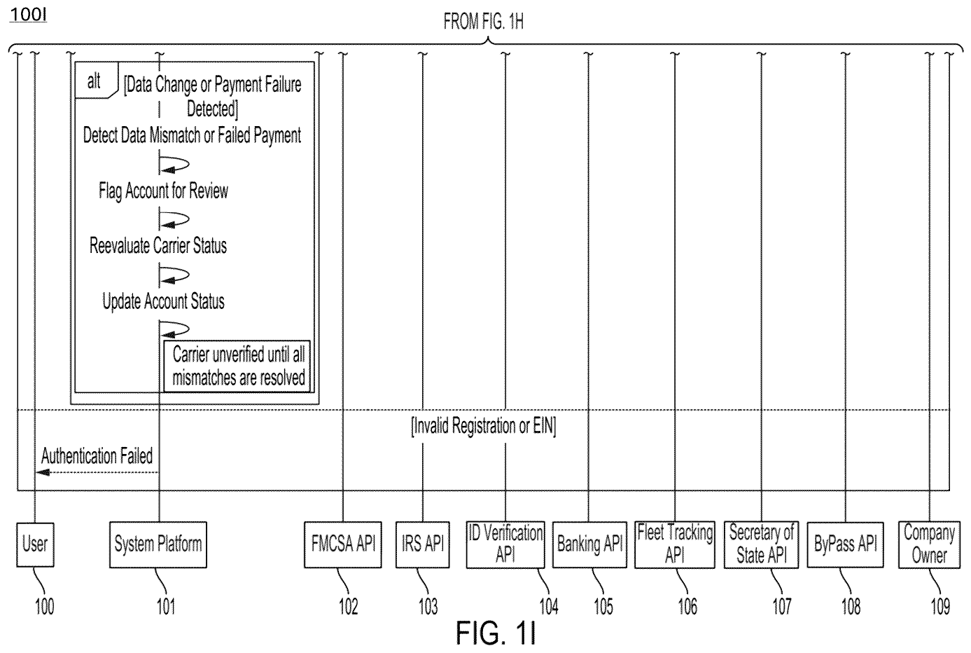

FIGS. 1A-1H illustrate views 100A-100I of an overall motor carrier verification process in accordance with an embodiment. For instance, in FIG. 1A, the process can include a number of communications and steps performed by any of a variety of entities or systems. These entities or systems can include a user 100, system platform 101, FMCSA API 102, IRS API 103, ID verification API 104, Banking API 105, fleet tracking API 106, Secretary of State API 107, ByPass API 108, and company owner 109.

The carrier's identity may be authenticated by providing their motor carrier number, which can be first formatted (200-202) and/or verified with the public records in order to assess if the potential user is a carrier or not (300-306). The validity of the carrier entity may be determined. Successful authentication may permit the provision of data related to individuals involved with this entity and/or the equipment (e.g., the fleet) and business services (e.g., fleet tracking, insurance) associated with those equipment and business operations (400-427). The data of individuals may be cross referenced to the same public record from which the entity was verified. The key stakeholder, the owner, may be responsible for verifying their identity and establishing ownership of the carrier entity (500-501). This can be completed in two parts. First, the individual may provide a valid personal ID to be verified. Second, their biometrics (e.g., facial) may be captured and referenced with internal or third-party services in order to validate the individual. The data pertaining to the owner may be used to cross reference previously assessed databases in previous steps. An algorithm can be used to track and reference the timestamp when this data is acquired and any sequential submission may be disqualified.

In some embodiments, the data of the key stakeholder now can be used to establish legal ownership (600-608) by linking the individual and the carrier entity to a financial institution and/or regulatory databases.

The entirety of the datasets now can be triangulated (700-721) across verified entities, individuals, business entities, and equipment in order to detect abnormalities and/or overlaps with other registrants. A system of rule-based logics and algorithms, including machine learning algorithms, may allow the platform to isolate affiliations between registrants and/or provide a verification status for the entity.

Changes to the datasets may automatically trigger these algorithms to reassess the verification status of the entity, providing the utility of continuous monitoring and status management (800-811) of motor carrier entities.

Status changes may further trigger the automatic generation and/or transmission of a notification (e.g., an email or in-app) to a relevant user (e.g., a carrier, owner, or any other user).

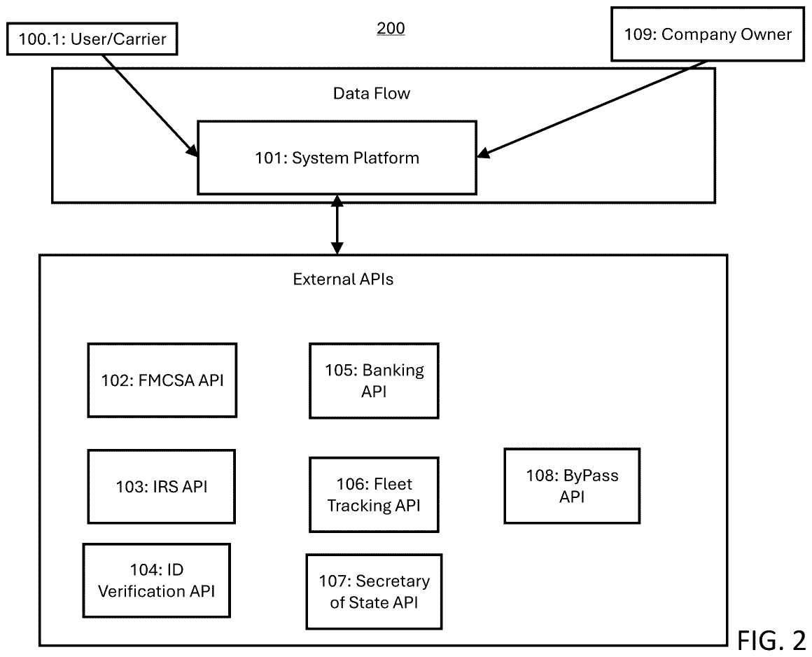

FIG. 2 illustrates the architectural framework 200 of the carrier verification system, depicting the interaction between users, the central system platform, and various external data sources. The diagram demonstrates how information can flow between different components and how the system integrates multiple verification sources. The core components of the carrier verification system may include the user/carrier (100) user interface, the system platform (101), and the company owner (109) user interface. The user/carrier (100) user interface may be the primary user interface where carriers or their representatives input required information into the system. The system platform (101) may act as the central processing hub that manages all data interactions and verification processes. The company owner (109) user interface may be a separate interface specifically for owner verification and banking connection processes.

In some embodiments, the system interfaces with multiple external data sources through secure API connections. The external data sources may be government data sources, verification services, or any other sources. For example, the government data sources may include the FMCSA API (102), which provides federal motor carrier registration and safety data, the IRS API (103), which validates Employer Identification Numbers (EIN) and tax information, and/or the Secretary of State API (107) which verifies business registration and ownership information. Example verification services may include the ID Verification API (104), which processes identity verification and document validation, the Banking API (105), which handles bank account verification and ownership confirmation, the Fleet Tracking API (106), which integrates with fleet management and location data, and/or the ByPass API (108), which provides additional carrier verification and historical data.

The System Platform (101) may act as the central hub, managing bidirectional communication between user inputs from carriers (100) and company owners (109), external API systems (102-108), and/or verification results and status updates. The architecture may ensure centralized data processing, consistent verification methodology, secure information handling, real-time status updates, and/or comprehensive data correlation.

The system's component architecture enables multiple layers of verification through simultaneous data source consultation, creating a robust verification framework that can identify and prevent fraudulent activities while maintaining efficient processing of legitimate carrier verifications.

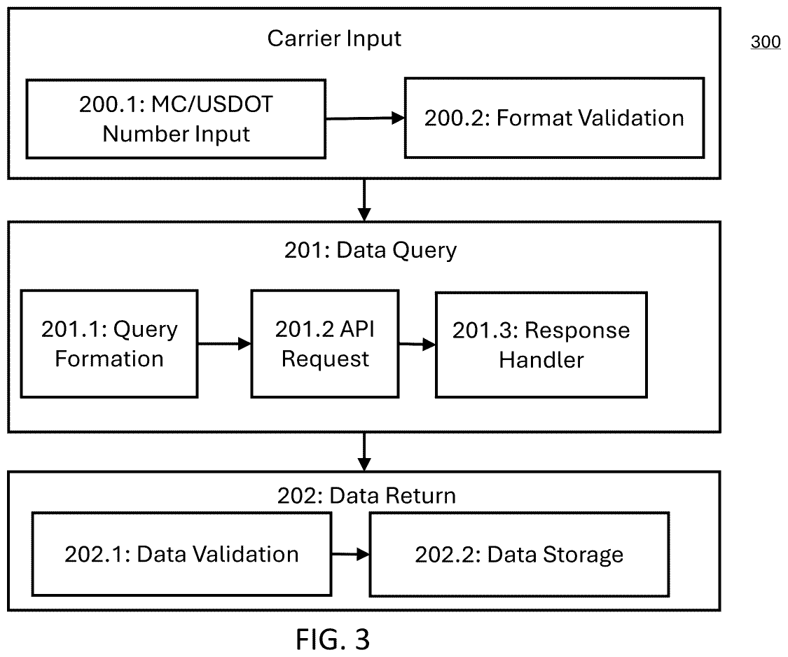

FIG. 3 illustrates the initial carrier identification process 300, detailing the sequence of steps from user input through data verification and storage, in accordance with an embodiment. The process can be divided into three main phases, each handling specific aspects of carrier identification. The three phases initial carrier input (200), public data query (201, and entry data return (202).

The initial carrier input (200) may include receiving a Motor Carrier (MC) or USDOT identification number (200), a format check (200.1) where the system validates the input format for correct length and character composition, and/or input storage (200.2) where a valid input is securely stored for processing. In some embodiments, the system may prompt the user to correct invalid input formats. Alternatively, the system may be configured to identify structure of the invalid input format and reformat the information into a valid input format.

The public data query process (201) may include query request formatting (201.1) where the system formats the identification number into appropriate query parameters, API Status Verification (201.2) where the system confirms the availability of the FMCSA (or other) API service, query transmission (201.3) where a formatted query is sent to FMCSA (or other) database, response monitoring (201.4) where the system awaits and monitors for an API response, and/or timeout handling (201.5), where the system manages cases when a response time exceeds thresholds.

Entity data return (202) may include response processing (202.1) where the system receives and processes the FMCSA (or other API) response data, data format validation (202.2) where the system verifies the structure and/or completeness of the returned data, data transformation (202.3) where the system transforms received data into system-compatible format, and/or entity data storage (202.4) where processed data is stored in the system database for subsequent verification steps.

The process may establish the foundation for subsequent verification steps by ensuring the carrier's basic identification is valid and properly recorded in the system. The sequence can include error handling and validation at each step to maintain data integrity and process reliability.

The identification process may represent a critical gateway in the overall verification system, as all subsequent verifications may depend on the accuracy and completeness of this initial data collection and validation phase.

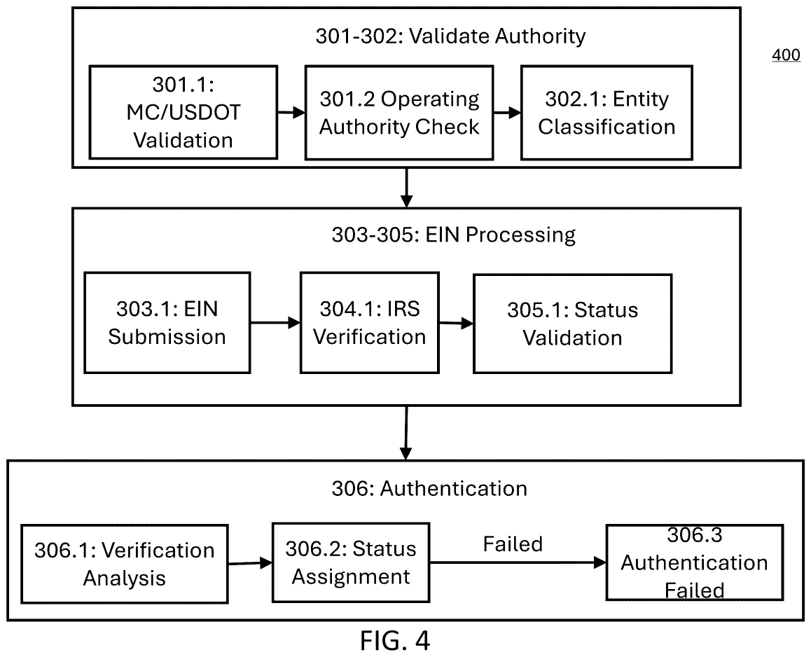

FIG. 4 depicts the comprehensive initial verification process 400 that validates the legitimacy of a carrier through multiple authoritative sources. The process may consist of sequential verification steps, each building upon the previous validation. The process may include MC/USDOT validation (301), entity classification (302), EIN verification (303-305), and result authentication (306).

MC/USDOT validation (301) may include a number format check (301.1), where the system performs detailed validation of the MC/USDOT number structure, active status verification (301.2), where the system confirms the operating status is current and valid, and an operating authority check (301.3) where the system verifies the carrier's authorization to operate.

Entity classification (302) may include authority type analysis (302.1) where the system examines the type of operating authority (e.g., from FMCSA), entity type determination (302.2) where the system distinguishes between carrier and broker classifications, and classification assignment (302.3) where the system assigns appropriate entity type in the system.

An EIN verification process (303-305) may include EIN Input Receipt (303.1) where the s system receives the carrier's tax identification number, IRS Query Formatting (304.1) where ethe system prepares EIN data for IRS validation, IRS submission (304.2) where the system transmits the EIN to the IRS for verification response processing (305.1) of the IRS verification response, and tatus Validation (305.2): Confirms EIN status and association with the business entity.

Result authentication (306) may include a comprehensive check evaluation (306.1) and final status generation (306.2). In the comprehensive check evaluation (306.1) the system may analyzes results from all verification steps. In final status generation (306.2) the system may determine overall verification status based the plurality of verification steps.

Furthermore, the system may be configured for authentication failure handling (306.3) to manage cases where verification requirements are not met. Authentication failure handing (306.3) may include requesting additional information from the user.

The initial verification process may serve as a critical filter, ensuring that only properly authorized and legitimate carriers proceed to subsequent verification stages. Each step can include specific validation criteria and error handling procedures to maintain the integrity of the verification system.

The process may be configured to detect and/or prevent unauthorized or improperly documented carriers from entering the system while efficiently processing legitimate carriers through the verification pipeline.

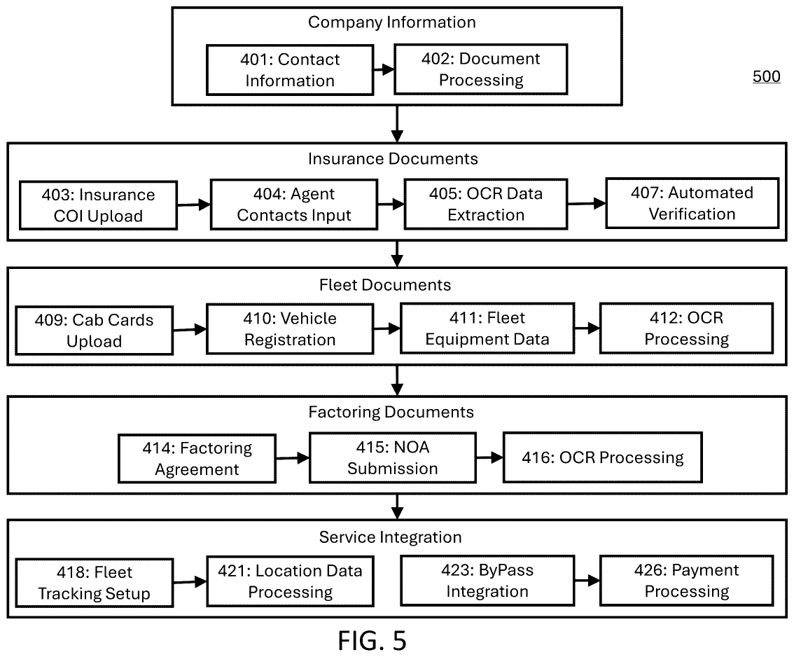

FIG. 5 illustrates the systematic collection and validation of company information through document processing, data extraction, and third-party integrations 500 in accordance with an embodiment. The process can be organized into distinct operational segments to ensure comprehensive data verification. The process may include basic information collection (400-401) which may include contact information submission (401) including the collection of primary company contact details and document processing initiation (402) as preparation for automated document analysis.

The methods disclosed herein may utilize data extraction techniques including optical character recognition (OCR) or natural language processing (NLP).

The process may include insurance documentation processing (403-408). Insurance documentation processing may include receiving Certificate of Insurance documentation (403), collection of insurance agent contact information (404), automated (e.g., OCR or NLP) extraction (405) of insurance details, analysis (406) of coverage details, exclusions, and/or dates, automated insurance verification (407), and provider confirmation (408) verified via communication with the insurance provider.

The process may include fleet documentation processing (409-413). Flee document processing may include the system receiving vehicle cab card documentation (409), the collection of vehicle registration documents (410), receiving detailed fleet information (411), automated extraction (e.g., via OCR) and processing of registration data, and data validation (413) of extracted VIN numbers, dates, and details.

The process may include factoring agreement processing (414-417). The factoring agreement processing may include receiving factoring agreement documentation (414), processing Notice of Assignment documentation (415), automated extraction (e.g., OCR or NLP) of factoring agreement details, and data storage (417) of company details, banking information, and terms.

The process may include service integration (418-427). Service integration may include setting up fleet tracking (418-422), including credential verification (418), access validation (419-420) and location data transformation (421-422). Location data transformation can anonymize locational data of drivers for security. For example, specific locational data may be anonymized to a region (e.g. a state).

The process may include ByPass integration (423-425). ByPass integration may include credential processing (423) and data retrieval (424-425).

The process may include payment processing (426-427). Payment processing may include payment information collection (426) and/or verification checkpoint establishment (427).

The comprehensive information collection process may ensure all necessary documentation is properly received, processed, and verified. The system may employ OCR or NLP technology to automate data extraction while maintaining accuracy through multiple validation checkpoints. Each segment may include specific security measures and data validation steps to maintain information integrity throughout the collection process.

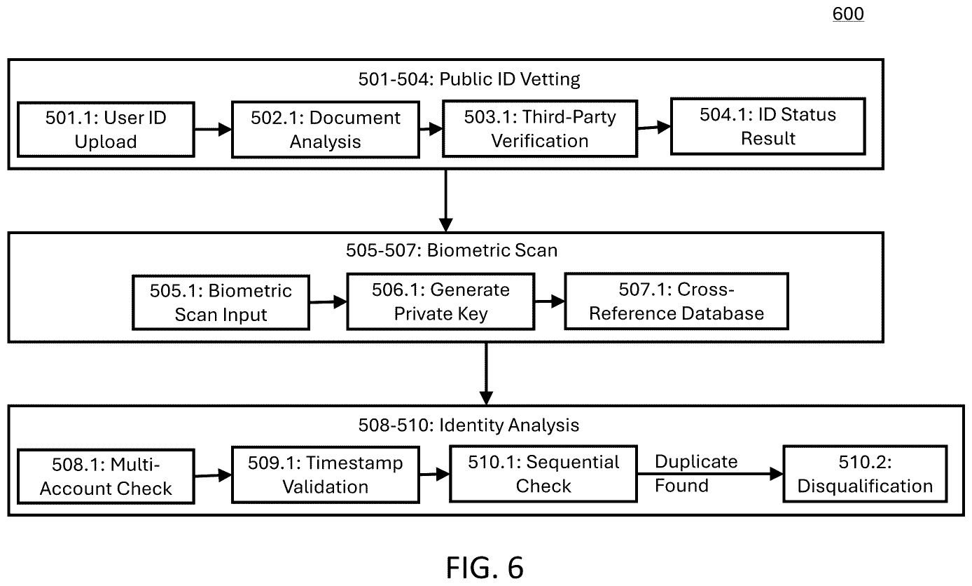

FIG. 6 demonstrates the multi-layered user identity verification process 600 that combines traditional document verification with advanced biometric validation and temporal analysis to prevent fraudulent activities in accordance with an embodiment.

The process may include public ID verification (500-504). Public ID verification may include receiving a government-issued identification document (501.1), document analysis (502.1) to verification of the public identification data, third-party verification (503.1) to validate ID authenticity, and processing a status result (504.1) of the verification outcome.

The process may include biometric processing (505-507). Biometric processing my include receiving or collecting a user's biometric data (505.1). The biometric data may be facial data. Facial data may be collected from the identification document. Alternative biometric data is also considered including, for example, fingerprints, voice recognition, iris scans, or any other biometric. Biometric processing may further include private key generation (506.1) where the private key is a unique biometric signature of the user. The biometric data may be cross-referenced (507.1) against existing records.

The process may include identity analysis (508-510). Identity analysis may include the system analyzing for matches across multiple MC accounts (i.e., multi-account detection (508.1)), timestamp validation (509.1) for verification of the temporal sequence of account creations, and/or a sequential check (510.1) analysis of signup patterns and timing. Suspicious sequential registrations may result in an automated disqualification (510.2).

The process may be configured to validate the authenticity of user identification through official documents, create unique biometric signatures for future reference, detect attempts to create multiple accounts by the same individual, prevent fraudulent sequential account creation, and/or establish verifiable links between users and their MC accounts.

The system may maintain separate processing of public and private identification data, using biometric information as a secure method to detect and prevent multiple account creation while protecting user privacy. The timestamp validation may provide an additional layer of security by identifying and preventing sequential fraud attempts.

The combination of document verification, biometric data, and temporal analysis may create a robust system for ensuring the uniqueness and legitimacy of each user registration while maintaining an efficient verification process for legitimate users.

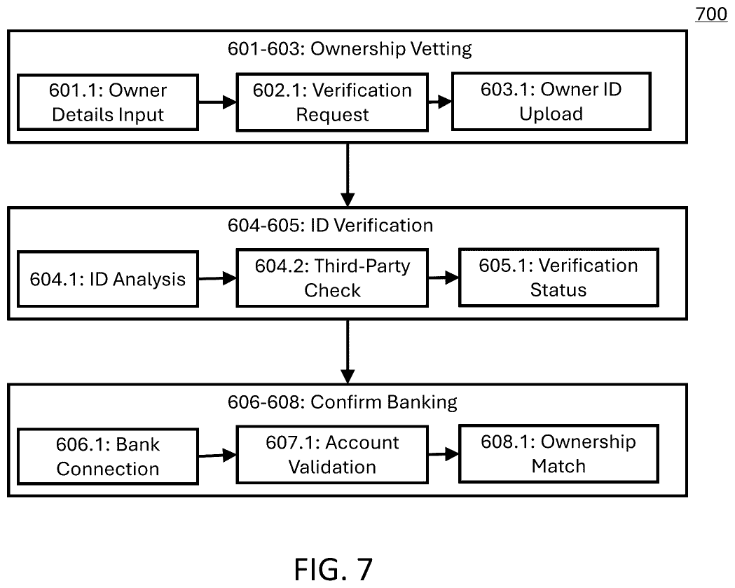

FIG. 7 outlines a process for verifying the legal ownership of a carrier company 700, utilizing multiple authoritative sources and financial verification methods in accordance with an embodiment.

The process may include owner information processing (600-603). Owner information processing may include collection of claimed owner's information (601.1), initiating a formal owner verification (602.1), and receiving an owner's government-issued identification (603.1).

The process may include identity verification (604-605). Identity verification may include and examination and analysis of submitted identification documents (604.1), an external (e.g., third-party) verification of identification authenticity (604.2), and processing/recording the verification results (605.1).

The process may include banking verification (606-608). Banking verification may include initiating secure banking integration (606.1), validation and verification of account ownership and status (607.1), and confirming ownership match (608.1) by cross-referencing banking data with owner information

The process may ensure legitimate ownership verification through official documentation, independent confirmation through banking relationships, and/or cross-validation of owner identity across multiple sources. The system may employ a three-pronged approach including documentary evidence through government ID, third-party identity verification, and financial institution validation.

The multi-source verification may create a robust framework for confirming legitimate company ownership while detecting potential fraudulent claims. The process can be configured to prevent unauthorized access to company accounts, ensure compliance with regulatory requirements, establish verifiable ownership records, and/or create audit trails for ownership validation. For example, insurance coverage dates may be monitored to ensure coverage is maintained.

Each step may include specific security measures and validation checkpoints, maintaining the integrity of the ownership verification process while facilitating legitimate business operations.

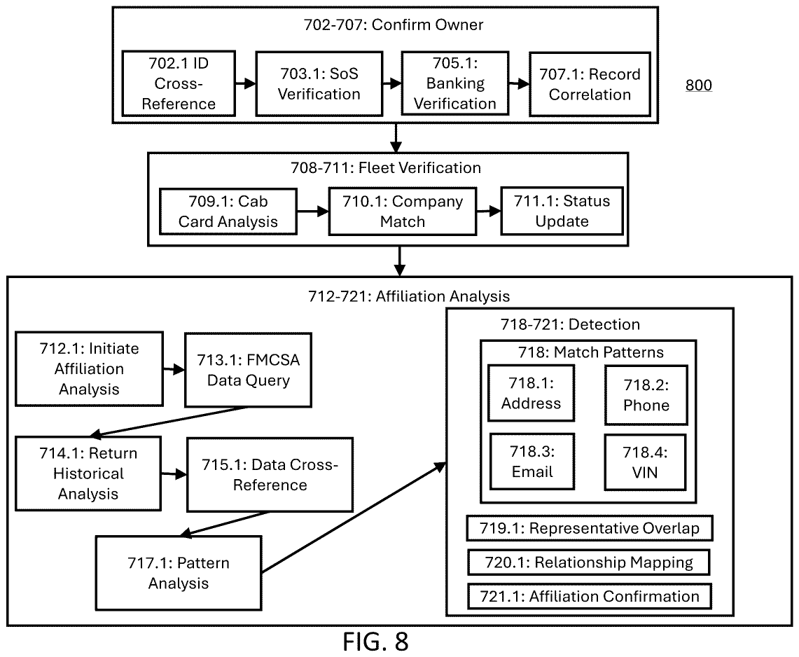

FIG. 8 illustrates a systematic process for carrier verification 800 through ownership validation, fleet verification, and affiliation analysis in accordance with an embodiment. The process may combine multiple data sources to establish legitimate business operations and detect potential fraud patterns.

The process may include ownership validation (700-707). Ownership validation may include analyzing and cross-referencing owner identification across submitted documents (702.1), validation against official business registrations (703.1), banking validation (705.1) through financial institution records, and/or record correlation (707.1) as a synthesis of all ownership verification data points.

The process may include fleet verification (708-711). Fleet verification may include verification (709.1) of submitted fleet documentation (e.g., cab cards), cross-referencing of company information with vehicle registrations (710.1), and recording of fleet verification results (711.1).

The process may include affiliation analysis (712-721). Affiliation analysis may include a systematic review of potential affiliations (712.1), a FMCSA data query (713.1) requesting carrier history, receiving of federal carrier data (714.1), comparing of public and private data sources on affiliation (715.1), and pattern analysis (717.1) of operational patterns.

The process may include detection analysis (718-721). Detection analysis may include pattern matching (718) (e.g., address analysis (718.1), phone number verification (718.2), email cross-referencing (718.3), and VIN validation (718.4)). Detection analysis may include identification of common personnel (i.e., overlap) across carriers (719.1), relationship mapping (720.1) of discovered connections, and affiliation confirmation (721.1) of carrier relationships.

The process may be configured to validate legitimate business operations, detect hidden relationships between carriers, identify potential fraud patterns, establish verifiable business networks, and/or maintain regulatory compliance.

The system may employ sophisticated pattern recognition to identify both legitimate business relationships and potentially fraudulent connections, creating a detailed map of carrier affiliations while maintaining operational integrity. The mapping may be stored in a relational database.

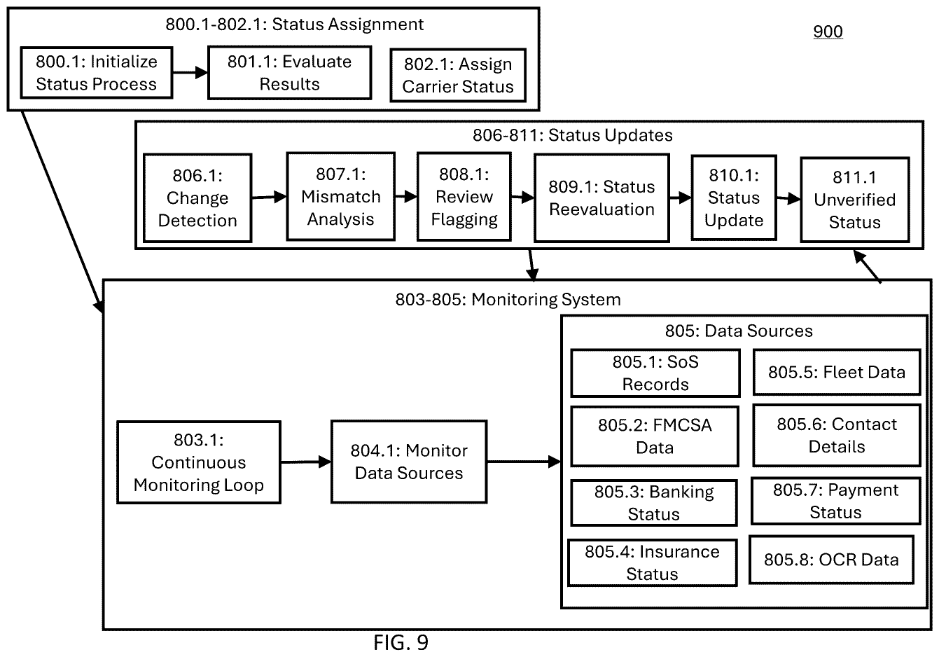

FIG. 9 illustrates a continuous monitoring system 900 that maintains carrier verification integrity through real-time data surveillance and automated status management in accordance with an embodiment.

The monitoring system may be configured for initial status assignment (800-802). Initial status assignment may include process initialization (800.1), analysis of all verification checkpoints (801.1), and carrier status assignment and recording (802.1).

The monitoring system (803-805) may operate in a continuous monitoring loop (803.1) for ongoing surveillance. The monitoring system may be configured for active tracking of verification components (804.1).

Data sources under surveillance may include, but are not limited to, Secretary of State records (805.1) (e.g., business registration status), FMCSA data (805.2) (e.g., federal compliance and authority), banking status (805.3) (e.g., financial account validity), insurance status (805.4) (e.g., coverage maintenance), fleet data (805.5) (e.g., vehicle registration compliance), contact details (805.6) (e.g., communication validity), payment status (805.7) (e.g., financial transaction status), and OCR Data (805.8) (e.g., document verification status)

The monitoring system may be configured to detect status updates in the data sources including change detection (806.1) (e.g., data discrepancies), mismatch analysis (807.1) (e.g., evaluation of detected changes), review flagging (808.1) (e.g., marking accounts for verification), status reevaluation (809.1) (needs comprehensively reviewed), status update (810.1) (e.g., the status is modified based on findings), and unverified status (811.1).

The process may ensure real-time monitoring of critical verification components, immediate detection of compliance issues, automated status management, continuous verification integrity, and/or proactive fraud prevention.

The system may maintain verification integrity through automated surveillance, ensuring carrier compliance while promptly identifying and addressing verification issues. The continuous monitoring may create a dynamic verification environment that adapts to changes in carrier status and compliance.

### Network Examples

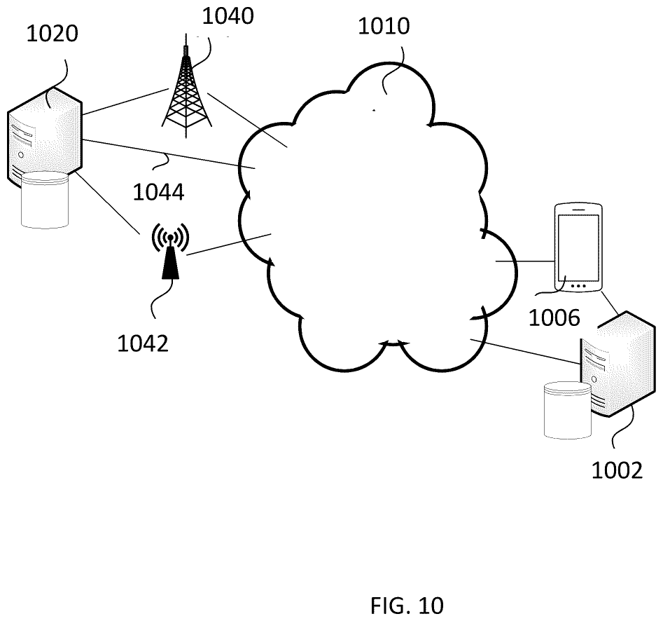

Systems and methods here may utilize a networked computing arrangement as shown in FIG. 10. The computer used for these steps could be any number of kinds of computers that are connected to any of the components as described herein, such as host PCB, wheel sensor PCB, motors, scrubbers, etc.

Turning back to FIG. 10, the data captured from whichever computer may be analyzed on a back end system instead of or in addition to a local computer. In such examples, data may be transmitted to a back end computer 1020 and associated data storage 1002 for saving, analysis, computation, comparison, or other manipulation. In some examples, additionally or alternatively, the transmission of data may be wireless 1040, 1042 by a cellular or Wi-Fi transmission with associated routers and hubs. In some examples, additionally or alternatively, the transmission may be through a wired connection 1044. In some examples, additionally or alternatively, the transmission may be through a network such as the internet 1010 to the back end server computer 1020 and associated data storage 1002. In some examples, additionally or alternatively, the data storing, analyzing, and/or processing may be shared between the local computer 1006 and a back end computing system 1020. In such examples, networked computer resources 1020 may allow for more data processing power to be utilized than may be otherwise available at the local computers. In such a way, the processing and/or storage of data may be offloaded to the compute resources that are available. In some examples, additionally or alternatively, the networked computer resources 1020 may be virtual machines in a cloud or distributed infrastructure. In some examples, additionally or alternatively, the networked computer resources 1020 may be spread across many multiple physical or virtual computer resources by a cloud infrastructure. The example of a single computer server 1020 is not intended to be limiting and is only one example of a compute resource that may be utilized by the systems and methods described herein. In some examples, additionally or alternatively, artificial intelligence and/or machine learning may be used to perform any of the steps as described herein.

### Example Computer Devices

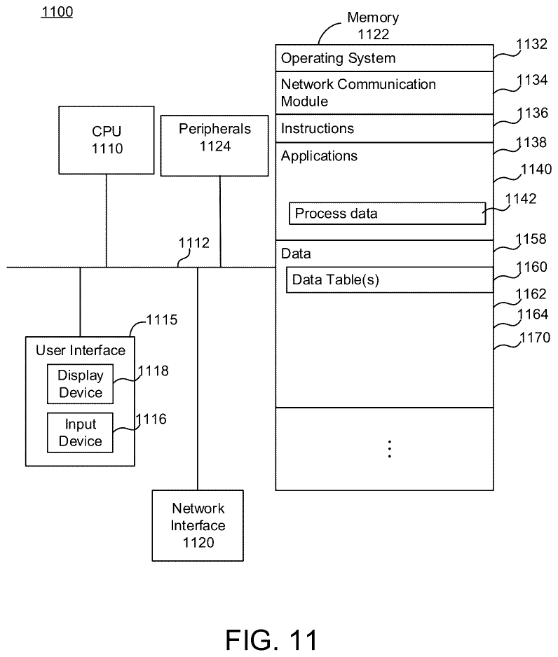

FIG. 11 shows an example computing device 1100 which may be used in the systems and methods described herein. In the example computer 1100 a CPU or processor 1116 is in communication by a bus or other communication 1112 with a user interface 1115. The user interface includes an example input device such as a keyboard, mouse, touchscreen, button, joystick, or other user input device(s). The user interface 1115 also includes a display device 1118 such as a screen. The computing device 1100 shown in FIG. 11 also includes a network interface 1120 which is in communication with the CPU 1110 and other components. The network interface 1120 may allow the computing device 1100 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing device 1100 includes peripherals 1124 also in communication with the processor 1116. The example computing device can interact with and manage communication and processing of data relating to any of the components as described herein.

In some examples computing device 1100 a memory 1122 is in communication with the processor 1116. In some examples, additionally or alternatively, this memory 1122 may include instructions to execute software such as an operating system 1132, network communications module 1134, other instructions 1136, applications 1138, or any other kind of data.

### CONCLUSION

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the methods and techniques described herein.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the description pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed:

1. A computer-implemented method for motor carrier verification, comprising:
receiving, by a processor, carrier identification data, biometric submissions comprising biometric data, and fleet data comprising location-specific data;
transforming, by the processor, location-specific data into regional data;
validating, by the processor via a network interface, the carrier identification data against a plurality of third-party databases;
processing, by the processor, an identity verification based on the biometric data;
analyzing, by the processor, temporal patterns of the biometric submissions;
cross-referencing, by the processor, carrier data between public and private sources;
determining, by the processor, a verification status based on the carrier identification data, regional data, identity verification, and temporal patterns; and
continuously monitoring, by the processor, verification status through automated data source surveillance.

2. The computer-implemented method of claim 1, wherein analyzing temporal patterns comprises:
storing, by the processor, timestamps of biometric submissions;
detecting, by the processor, sequential submission patterns;
identifying, by the processor, multiple submissions across different carrier accounts; and
automatically disqualifying, by the processor, subsequent submissions from previously verified individuals.

3. The computer-implemented method of claim 1, wherein cross-referencing carrier data comprises:
extracting, by the processor, data through optical character recognition from documentation, wherein the carrier identification data comprises the documentation;
validating, by the processor, portions of the extracted data against government records;
verifying, by the processor, banking relationships in the extracted data against banking records;
confirming, by the processor, insurance coverage in the extracted data through automated provider communication; and
detecting, by the processor, affiliated entities through pattern matching of the extracted data.

4. The computer-implemented method of claim 1, wherein continuously monitoring verification status further comprises:
collecting, by the processor, carrier operational data comprising contact information and vehicle identification numbers;
analyzing, by the processor, patterns in the contact information;
comparing, by the processor, vehicle identification numbers across carriers;
detecting, by the processor, representative overlap between carriers; and
generating, by the processor, relationship maps based on the representative overlap.

5. The computer-implemented method of claim 1 further comprising:
receiving, by the processor, real-time carrier data from FMCSA databases;
storing, by the processor, snapshots of the real-time carrier data at predetermined intervals;
creating, by the processor, temporal relationships between the snapshots;
generating, by the processor, historical patterns from temporal relationships;
detecting, by the processor, changes in carrier status over time based on the historical patterns; and
establishing, by the processor, baseline operational patterns for continuous monitoring based on the changes in carrier status.

6. The computer-implemented method of claim 5, wherein generating historical patterns comprises:
aggregating, by the processor, sequential snapshots;
identifying, by the processor, temporal relationships between changes in carrier status;
creating, by the processor, carrier activity timelines based on the temporal relationships and aggregated snapshots;
detecting, by the processor, patterns in operational changes based on the carrier activity timelines; and
establishing, by the processor, normal versus abnormal behavior patterns based on the patterns in operational changes.

7. The computer-implemented method of claim 5, further comprising:
correlating, by the processor, the historical patterns with the real-time carrier data;
identifying, by the processor, deviations from the historical patterns;
generating, by the processor, risk assessments based on deviations;
predicting potential compliance issues based on the risk assessments; and
automatically adjusting continuous monitoring frequency based on the potential compliance issues.

8. The computer-implemented method of claim 1, further comprising:
receiving, by the processor, banking credentials from a purported owner;
obtaining, by the processor, business registration data from Secretary of State records;
retrieving, by the processor, carrier authorization data from FMCSA databases;
collecting, by the processor, vehicle registration documentation;
triangulating, by the processor, ownership information across the banking credentials, the Secretary of State records, the carrier authorization data, the vehicle registration documentation, and the biometric data;
generating, by the processor, an ownership confidence score based on the triangulation; and
establishing, by the processor, legal ownership identity based on the ownership confidence score.

9. The computer-implemented method of claim 8, wherein triangulating ownership information comprises:
matching, by the processor, business names and business addresses from the banking credentials, the business registration data, the carrier authorization data, and the vehicle registration documentation;
comparing, by the processor, ownership names across the banking credentials, the business registration data, the carrier authorization data, and the vehicle registration documentation;
validating, by the processor, consistency of the business addresses;
verifying, by the processor, consistency of the ownership names;
cross-referencing, by the processor, the biometric data against the ownership names; and
identifying, by the processor, temporal patterns in the ownership names through biometric submissions.

10. The computer-implemented method of claim 8, further comprising:
establishing, by the processor, temporal sequence of the ownership information;
detecting, by the processor, ownership changes from at least one of the banking credentials, the business registration data, the carrier authorization data, and the vehicle registration documentation;
identifying, by the processor, attempts to claim multiple ownerships based on the biometric submissions;
automatically flagging, by the processor, ownership discrepancies based on the attempts to claim multiple ownerships and the ownership changes;
in response to flagging:
requesting, by the processor, additional verification; and
preventing, by the processor, sequential ownership claims based on the biometric submissions; and
maintaining, by the processor, continuous ownership validation through the continuous monitoring.

11. A system for motor carrier verification, comprising:
a processor; and
a non-transitory, processor-readable storage medium, wherein the non-transitory, processor-readable storage medium comprises one or more programming instructions that, when executed, cause the processor to:
receive carrier identification data, biometric submissions comprising biometric data, and fleet data comprising location-specific data;
transform location-specific data into regional data;
validate, via a network interface, the carrier identification data against a plurality of third-party databases;
process an identity verification based on the biometric data;
analyze temporal patterns of the biometric submissions;
cross-reference carrier data between public and private sources;
determine a verification status based on the carrier identification data, regional data, identity verification, and temporal patterns; and
continuously monitor verification status through automated data source surveillance.

12. The system of claim 11, wherein the one or more programming instructions that cause the processor to analyze temporal patterns further cause the processor to:
store timestamps of biometric submissions;
detect sequential submission patterns;
identify multiple submissions across different carrier accounts; and
automatically disqualify subsequent submissions from previously verified individuals.

13. The system of claim 11, wherein the one or more programming instructions that cause the processor to cross-reference carrier data further cause the processor to:
extract data through optical character recognition from documentation, wherein the carrier identification data comprises the documentation;
validate portions of the extracted data against government records;
verify banking relationships in the extracted data against banking records;
confirm insurance coverage in the extracted data through automated provider communication; and
detect affiliated entities through pattern matching of the extracted data.

14. The system of claim 11, wherein the one or more programming instructions that cause the processor to continuously monitor verification status further cause the processor to:
collect carrier operational data comprising contact information and vehicle identification numbers;
analyze patterns in the contact information;
compare vehicle identification numbers across carriers;
detect representative overlap between carriers; and
generate relationship maps based on the representative overlap.

15. The system of claim 11, wherein the one or more programming instructions further cause the processor to:
receive real-time carrier data from FMCSA databases;
store snapshots of the real-time carrier data at predetermined intervals;
create temporal relationships between the snapshots;
generate historical patterns from temporal relationships;
detect changes in carrier status over time based on the historical patterns; and
establish baseline operational patterns for continuous monitoring based on the changes in carrier status.

16. The system of claim 15, wherein the one or more programming instructions that cause the processor to generate historical patterns further cause the processor to:
aggregate sequential snapshots;
identify temporal relationships between changes in carrier status;
create carrier activity timelines based on the temporal relationships and aggregated snapshots;
detect patterns in operational changes based on the carrier activity timelines; and
establish normal versus abnormal behavior patterns based on the patterns in operational changes.

17. The system of claim 15, wherein the one or more programming instructions further cause the processor to:
correlate the historical patterns with the real-time carrier data;
identify deviations from the historical patterns;
generate risk assessments based on deviations;
predict potential compliance issues based on the risk assessments; and
automatically adjust continuous monitoring frequency based on the potential compliance issues.

18. The system of claim 11, wherein the one or more programming instructions further cause the processor to:
receive banking credentials from a purported owner;
obtain business registration data from Secretary of State records;
retrieve carrier authorization data from FMCSA databases;
collect vehicle registration documentation;
triangulate ownership information across the banking credentials, the Secretary of State records, the carrier authorization data, the vehicle registration documentation, and the biometric data;
generate an ownership confidence score based on the triangulation; and
establish legal ownership identity based on the ownership confidence score.

19. The system of claim 18, wherein the one or more programming instructions that cause the processor to triangulate ownership information further cause the processor to:
match business names and business addresses from the banking credentials, the business registration data, the carrier authorization data, and the vehicle registration documentation;
compare ownership names across the banking credentials, the business registration data, the carrier authorization data, and the vehicle registration documentation;
validate consistency of the business addresses;
verify consistency of the ownership names;
cross-reference the biometric data against the ownership names; and
identify temporal patterns in the ownership names through biometric submissions.

20. The system of claim 18, wherein the one or more programming instructions further cause the processor to:
establish temporal sequence of the ownership information;
detect ownership changes from at least one of the banking credentials, the business registration data, the carrier authorization data, and the vehicle registration documentation;
identify attempts to claim multiple ownerships based on the biometric submissions;
automatically flag ownership discrepancies based on the attempts to claim multiple ownerships and the ownership changes;
in response to flag:
request additional verification; and
prevent sequential ownership claims based on the biometric submissions; and
maintain continuous ownership validation through the continuous monitoring.
